(19) United States
(12) Patent Application Publication
(10) Pub. No.: US 2008/0075654 A1
(43) Pub. Date: Mar. 27, 2008

(54) Titanium dioxide process

(76) Inventor: Matthew E. Jamison, Warren, OH (US)

Correspondence Address: KING & SPALDING, 1185 AVENUE OF THE AMERICAS, NEW YORK, NY, 10036-4003, US

(21) Appl. No.: 11/524,570

(22) Filed: Sep. 21, 2006

(51) Int. Cl. C01G 23/047

(52) U.S. Cl. 423/613

(57) ABSTRACT

A process for producing titanium dioxide is disclosed. The process is cooled with liquid titanium tetrachloride in a gas-phase reaction. This enables good temperature control of the exothermic reactions even at high production rates.

### FIELD OF THE INVENTION

This invention relates to a process for producing titanium dioxide in a gas-phase reactor. The process enables good temperature control.

### BACKGROUND OF THE INVENTION

Titanium dioxide pigments have many known applications, particularly for uses in coatings, paper, and plastics. The manufacture of titanium dioxide pigment is commercially performed by either the sulfate process or the chloride process. In the chloride process, titanium dioxide is manufactured by reacting gaseous titanium tetrachloride with oxygen gas. The gaseous mixture must be at a high temperature to effect the reaction and oxygen is preheated prior to combination with hot titanium tetrachloride. However, the reaction is exothermic and temperatures can be difficult to control. If the temperature is too high, the corrosion rates on the materials used to construct the reactors can be unacceptably high. Also, as the temperatures become high, the titanium dioxide particles can agglomerate and particle size can be undesirably high. This is disclosed, for example, in U.S. Pat. No. 3,512,219, where many of the difficulties of the reaction, such as effect of different temperatures of the gaseous mixture on the product quality and the issues with reactor material of construction due to the high temperature and corrosive nature of the gaseous mixture are discussed. They propose expensive metals or ceramics and external cooling as a partial solution to these problems. No liquid titanium tetrachloride is used.

U.S. Pat. No. 5,840,112 improves the pigment properties of titanium dioxide by performing the reaction in two zones. Oxygen gas is preheated and added to each zone with the oxygen added to the second zone gas at a substantially lower temperature than the oxygen added to the first zone. The walls of the reactor can be cooled to reduce deposition. Titanium tetrachloride introduced into the reactor is at a temperature of at least 572° F. (300° C.). One described technique is to react a mixture of titanium tetrachloride and chlorine with aluminum metal to generate aluminum chloride. The heat of the reaction serves, in part, to heat the titanium tetrachloride. Titanium tetrachloride containing aluminum chloride is introduced to a two-zone reactor and combined with oxygen to form titanium dioxide and alumina. The aluminum chloride present promotes the formation of rutile titanium dioxide. No liquid titanium tetrachloride is used.

U.S. Pat. No. 6,387,347 discloses a multi-stage gas phase oxidation reactor wherein only a portion of the titanium tetrachloride is added to the first reactor zone and the remainder of the titanium tetrachloride is added to subsequent reactor zones. The temperature of the first zone is controlled by limiting the portion of titanium tetrachloride fed to zone one. Liquid titanium tetrachloride is added to the gaseous titanium tetrachloride added to a second or subsequent reactor stage. No liquid titanium tetrachloride is added prior to the second stage. The goal is to lower the feed temperature of the second zone. Similarly, U.S. Pat. No. 5,840,112 discloses oxygen added to the second zone gas at a substantially lower temperature than the oxygen added to the first zone.

Despite the considerable issues with the high reaction temperatures and the difficulties in controlling these temperatures, the focus seems to be on second and subsequent reactor zones. Apparently there has been no contemplation of cooling any parts of the process prior to the second oxidation stage with liquid titanium tetrachloride. Previous efforts to control temperatures prior to the second oxidation stage have relied on either limiting the heat generated by the reaction by limiting the amount of reactants or have relied on external cooling. Limiting the amount of reactants is undesirable because it limits the capacity of the process. External cooling depends on surface area and is often inadequate, especially at high production rates.

### SUMMARY OF THE INVENTION

The invention is a process for producing titanium dioxide in a gas-phase reactor. Liquid titanium tetrachloride is used to cool titanium tetrachloride gas entering the first stage of the reactor. In another embodiment, liquid titanium tetrachloride is added to an aluminum chloride generator to cool a gaseous mixture of titanium tetrachloride with aluminum chloride produced by the reaction of aluminum with a gaseous mixture of titanium tetrachloride gas and chlorine. The process enables good temperature control which in turn enables several other improvements in the process and in product quality.

### DETAILED DESCRIPTION OF THE INVENTION

The invention is a process for producing titanium dioxide in a gas-phase reactor. In the reactor, titanium tetrachloride gas reacts with oxygen to form titanium dioxide and chlorine. The reaction is highly exothermic. To help control the heat released, preferably a portion of the reaction is done in each of at least two stages or zones of the reactor. Preferably, a two stage reactor is used, but three or more stages can also be used in the process. Preferably, a portion of the titanium tetrachloride gas is added to each of the stages. The portion can be adjusted to control the amount of reaction that takes place in each stage and the amount of heat generated. When the reactor is a two-stage reactor, preferably 30-80% by weight of the total titanium tetrachloride fed to the reactor is fed to the first stage. More preferably, 40-60% by weight is fed to the first stage. The total titanium chloride fed to the reactor is the combined amount of the titanium tetrachloride gas and the liquid titanium tetrachloride.

The oxygen-containing gas can be added to the first stage and unreacted oxygen from the first stage used in subsequent stages. Alternatively, the oxygen-containing gas can be added to each of the stages of the reactor. The oxygen-containing gas can be any that contains a sufficient amount of oxygen to convert the titanium tetrachloride to titanium dioxide. Suitable oxygen-containing gases include air, oxygen enriched air, or substantially pure oxygen. Optionally, the oxygen-containing gas contains water vapor, preferably from 50 ppm to 200,000 ppm by weight based upon the amount of titanium dioxide produced. Preferably, the oxygen-containing gas is preheated prior to addition to the reactor where it is mixed with the titanium tetrachloride. Preheating the oxygen-containing gas facilitates the reaction with titanium tetrachloride, but excessive preheating makes it more difficult to control the heat generated by the reaction with titanium tetrachloride. Preferably, the oxygen-containing gas is preheated to a temperature between 500° C. to 1000° C. Optionally, in a combustion chamber, the gas temperature may be further increased by the combustion of a suitable fuel such as a hydrocarbon.

The titanium tetrachloride gas added to the reactor can be substantially pure or it may be a mixture with other components. Preferably, the titanium tetrachloride gas will be a mixture with chlorine and aluminum chloride. When the titanium tetrachloride gas is a mixture, preferably, it is greater than 90% by weight titanium tetrachloride. When aluminum chloride is present in the mixture, preferably it is generated earlier in the process by reacting chlorine with aluminum in an aluminum chloride generator. Preferably, excess chlorine is used. The aluminum chloride and any excess chlorine can be combined with titanium tetrachloride and the mixture added to the gas-phase reactor. Preferably, a gaseous mixture of chlorine and titanium tetrachloride is added to aluminum in an aluminum chloride generator and the gaseous product mixture of titanium tetrachloride, excess chlorine, and aluminum chloride added to the gas-phase reactor. Reaction with oxygen provides a mixture of titanium dioxide and aluminum oxide. The aluminum chloride promotes the formation of rutile titanium dioxide. Preferably, the amount of aluminum chloride generated is sufficient to produce between 0.2% to about 2.0% by weight of alumina in the product titanium dioxide.

The process is cooled with liquid titanium tetrachloride. In one embodiment, liquid titanium tetrachloride is mixed with the titanium tetrachloride gas prior to addition to the first stage of the gas-phase reactor. This removes heat from the titanium tetrachloride gas due to the lower temperature of the liquid titanium tetrachloride and due to the vaporization of the liquid upon contact with the hot gas. Preferably, liquid titanium tetrachloride is added in an amount sufficient to maintain the titanium tetrachloride gas entering the first stage at a temperature of from 200° to 500° C. The liquid can be added by any technique. Preferably, the liquid is added through several nozzles or as a spray to aid in contact with the gas. Desuperheaters are equipment commonly used to control steam temperatures by means of a water spray. The use of a desuperheater is a preferred method for contacting the liquid titanium tetrachloride with the gas. Optionally, temperature of subsequent stages may also be cooled with liquid titanium tetrachloride.

In another embodiment, liquid titanium tetrachloride is added to the aluminum generator. The reaction of aluminum with chlorine is highly exothermic and it can be difficult to control the temperature of the aluminum chloride generator. Addition of varying amounts of liquid titanium tetrachloride allows good control of the temperature. Preferably, the liquid titanium tetrachloride is added as a spray to the aluminum chloride generator.

Optionally, liquid titanium tetrachloride can be added both to the aluminum chloride generator and to the titanium tetrachloride gas entering the gas-phase reactor. The amount of liquid titanium tetrachloride will vary dependent upon the required heat removal. Both the reaction of chlorine with aluminum and the reaction of titanium tetrachloride with oxygen are highly exothermic reactions. As the production rate increases, more heat is generated, and more liquid can be used to control the temperature by cooling.

The following examples merely illustrate the invention. Those skilled in the art will recognize many variations that are within the spirit of the invention and scope of the claims.

### EXAMPLE 1

Air at a temperature of 1390° C. is reacted with titanium tetrachloride in a two-stage gas phase reactor. Gaseous titanium tetrachloride fed to the reactor is split with 60% by weight being fed to the first stage. Liquid titanium tetrachloride is added to cool the titanium tetrachloride gas entering the first stage to a temperature of 282° C. Titanium tetrachloride gas enters the second stage without cooling at a temperature of 477° C. The reactor is modeled using Computational Fluid Dynamics (CFX software available from ANSYS Inc.) for flow field inside the reactor stages and using Population Balance Modeling for particle formation and growth. Based upon modeling data, the mean particle size of the titanium dioxide is expected to be 0.297 microns.

### COMPARATIVE EXAMPLE 2

Titanium dioxide is formed in similar fashion as in Example 1, but without cooling the titanium tetrachloride entering the first stage. The titanium tetrachloride gas entering each stage is at a temperature of 477° C. Based upon the same modeling as in Example 1, the mean particle size of the titanium dioxide is expected to be 0.307 microns.

Example 1 versus Comparative Example 2 shows the ability to control the temperature of the titanium tetrachloride gas entering the first stage and the improvement in particle size (smaller particle size).

### EXAMPLE 3

Titanium dioxide is formed in similar fashion as in Example 1, but the titanium tetrachloride gas entering both the first and second stage is cooled to a temperature of 282° C. The mean particle size of the titanium dioxide is expected to be 0.277 microns.

### COMPARATIVE EXAMPLE 4

Titanium dioxide is formed in similar fashion as in Example 3, but without cooling the titanium tetrachloride entering the first stage. The titanium tetrachloride gas entering the first stage is at a temperature of 477° C. and the gas entering the second stage is cooled with liquid titanium tetrachloride to a temperature of 282° C. The mean particle size of the titanium dioxide is expected to be 0.286 microns.

Example 3 versus Comparative Example 4 shows the ability to control the temperature of the titanium tetrachloride gas entering the first stage and the improvement in particle size (smaller particle size) achieved when the gas entering the first stage is cooled even when the temperature of the second stage is also cooled.

The preceding examples are meant only as illustrations. The following claims define the invention.

I claim:

1. A process for producing titanium dioxide in a gas-phase reactor comprising reacting titanium tetrachloride gas and an oxygen-containing gas wherein the titanium tetrachloride gas is cooled by mixing with liquid titanium tetrachloride prior to addition into a first stage of the reactor.

2. The process of claim 1 wherein the liquid titanium tetrachloride is combined with the titanium tetrachloride gas in a desuperheater.

3. The process of claim 1 wherein titanium tetrachloride gas entering a second stage of the reactor is cooled by addition of liquid titanium tetrachloride.

4. The process of claim 1 wherein the gas-phase reactor is a two-stage reactor.

5. The process of claim 4 wherein 30 to 80 percent by weight of the total titanium tetrachloride fed to the two-stage reactor is fed to the first stage.

6. The process of claim 5 wherein 40 to 60 percent by weight of the total titanium tetrachloride is fed to the first stage.

7. The process of claim 4 wherein the titanium tetrachloride gas entering the first stage is maintained at a temperature from 200° C. to 500° C.

8. The process of claim 4 wherein the titanium tetrachloride gas entering the first stage is maintained at a temperature from 200° C. to 350° C.

9. The process of claim 1 wherein aluminum chloride is added to the titanium tetrachloride gas.

10. A process for producing titanium dioxide in a gas-phase reactor comprising:
(a) reacting aluminum with a gaseous mixture of chlorine and titanium tetrachloride in an aluminum chloride generator to provide a gaseous mixture of titanium tetrachloride and aluminum chloride; and
(b) reacting the gaseous mixture of titanium tetrachloride and aluminum chloride with an oxygen-containing gas in a gas-phase reactor to produce titanium dioxide,
wherein the gaseous mixture of titanium tetrachloride and aluminum chloride is cooled by adding liquid titanium tetrachloride into the aluminum chloride generator.

11. The process of claim 10 wherein the liquid titanium tetrachloride is added as a spray to the aluminum chloride generator.
